(19) United States
(12) Patent Application Publication
(10) Pub. No.: US 2005/0061883 A1
(43) Pub. Date: Mar. 24, 2005

(54) Device for establishing a communication link to cards of different types

(76) Inventors: Norbert Miller, Monchengladbach (DE); Metin Cakmakli, Tonisvorst (DE)

Correspondence Address: CANTOR COLBURN, LLP, 55 GRIFFIN ROAD SOUTH, BLOOMFIELD, CT, 06002, US

(21) Appl. No.: 10/930,386

(22) Filed: Aug. 31, 2004

(30) Foreign Application Priority Data
Sep. 18, 2003 (EP) 03021075.1

(51) Int. Cl. G06K 5/00; G06K 7/00; G06K 7/06; G06K 7/08

(52) U.S. Cl. 235/440; 235/441; 235/451

(57) ABSTRACT

“The invention pertains to a device and a method for establishing a communication link to cards with different usage functions, where the device includes at least two control units, which are suitable for different card usage functions, a reading unit, which is suitable for the different card usage functions, and a multiplexer that is linked to the reading unit for communication purposes and by means of which the communication link can be established to the control unit that is suitable for the card usage function in question.”

The present invention pertains to a device for establishing a communication link to cards with different usage functions, whereby the device comprises at least two control units that are suitable for different card usage functions, together with a process for this purpose.

Such devices are known in numerous forms, e.g. as vending machines, as automatic access machines, time registration systems, or the like.

Thus it is known, for example, that access to buildings or parcels of land can be permitted via security relevant devices only to authorized persons as a result of providing these persons with authorization passes in the form of magnetic cards, chip cards, time cards, authorization cards, or the like that are verified manually and/or by means of an automatic machine at an access location, whereby access is granted in the event of a positive result of the verification. Similar devices are also known when departing from buildings or parcels of land, for which it is important that protective actions are carried out upon departure. Such an arrangement is provided, for example, in the case of nuclear power plants in which the person is examined for contamination by radioactive substances upon departing from the security relevant area.

However, a plurality of devices is also known in our daily surroundings, e.g. vending machines for products or the provision of services that permit payment without using cash. Such devices are e.g. vending machines for products, vending machines for tickets for travel purposes, vending machines for beverages, or the like. In order to simplify the tedious implementation of the payment transaction, the devices are provided with a unit, which makes it possible to pay without cash, either instead of, or in addition to, the possibility of payment with cash. In this way, for example, the device can be provided with a unit that creates the possibility of payment by means of one of the current types of cards such as credit cards, EC cash, cash cards, authorization cards, or the like. All these types of cards represent a plurality of different card usage functions.

It is desirable from the standpoint of the customer or user that the device have available a plurality of payment options so that the customer will have the possibility, on the one hand, of selecting the payment possibility that is most favorable for him and, in addition, that he can then also carry out a payment transaction if he has only one particular non-cash means of payment at his disposal. A vending machine that does not have a unit that is suitable for this means of payment exhibits a considerable competitive disadvantage.

On the basis of the previously known non-cash payment possibilities, it is necessary, under certain circumstances, for several units to be integrated into one device in order to carry out payment transactions, whereby each unit is provided for one specific card usage function. An arrangement of several units is very cost intensive in terms of manufacture and, in addition, it requires high approval costs for the particular control unit that is intended for communication with the envisaged types of cards.

If, for example, several openings for different means of payment, such as credit cards, EC cards, or the like, are present on a vending machine, then there is a risk that the user of the vending machine will use the wrong input slot for his means of payment for the payment transaction. The consequence is an abortion of the payment transaction. The user now has to repeat all the input steps up to the point of the payment transaction, assuming that he is still interested in the product or the provision of the service. Many a user despairs, especially if abortion takes place several times and he will then desist from further use of the vending machine. Moreover, it has proven to be disadvantageous if the installation of such a vending machine at a later time for a new type of card requires high costs that equate with the purchase of a new vending machine.

Such known processes also prove to be disadvantageous or very complex and therefore cost intensive in the area of authorization of usage, e.g. access. The term usage should not only be understood to mean the utilization of objects, but also access authorizations, e.g. to buildings, parcels of land, or the like. Thus it is desirable, for example, that only authorized personnel be granted access to a construction site at which these personnel are to carry out planned activities. Unauthorized third parties are to be kept away from the construction site, e.g. in order to avoid accidents or even to facilitate undisturbed operation. Thus, for example, the workers can be provided with an access card whose verification at an access location permits access to the construction site. A disadvantageous feature is that the existing system can be used only for one specific type of card that is provided for this purpose, so that one has to ensure that the authorized persons are provided with one type of access card. In addition to this, such a system proves to be inflexible since changes, such as new authorizations or their cancellation, involve a great deal of administrative work.

It is therefore the object of the present invention to create a device and a process by means of which the use of different types of card is made possible in an inexpensive manner, whereby this process is adaptable, at low cost, to new card usage functions.

The term card type within the framework of this disclosure is to be understood to mean any type of card that can be provided with information that can be queried, e.g. magnetic cards, chip cards, credit cards, cash cards, EC cards, personnel identification, a driver's license, stamped cards, time cards, etc.

A device of this type is proposed, via the invention, as a solution [to the aforementioned problem], whereby this device has a reading unit, which is suitable for different card usage functions, and a multiplexer that is linked to the reading unit for communication and by means of which the communication link can be established to the control unit that is suitable for the card usage function.

It is thus possible, for the first time, to provide a device for a plurality of different card usage functions, especially non-cash payment possibilities, whereby the cost that is to be additionally incurred is low relative to the known devices of the prior art. The arrangement involving a multiplexer, via which the control unit that is suitable for communication for the card usage function in question is linked to the reading unit, permits simple operation at low additional cost. The reading unit or even a computing unit establishes the type of card that is involved, e.g. a non-cash means of payment, and enters into communication with the pertinent control unit via the multiplexer, so that the intended exchange of data can be carried out. In addition, use can also be made of control units that have already been approved, whereby these control units can be linked to the reading unit via the multiplexer. In this way, for example, a suitable control unit, which has already been approved, can be used for any means of payment. Complex systems with different reading units and openings for introducing and withdrawing the card can be avoided. In addition, the present invention offers the possibility of permitting a plurality of card usage functions without considerable development costs and expense. A complex multifunction control unit can be avoided. Devices that already exist can also be retrofitted at low cost, e.g. by adding new control units for additional card usage functions or even by removing a control unit if the associated card usage function is no longer accepted. The device in accordance with the invention permits the use of control units that have already been approved, so that the high cost of approving a newly developed multifunction control unit can be saved.

It is also proposed that the device comprise a computing unit. It is beneficial if the data from the card can be stored and/or read. In addition, data processing can be achieved in order to be able to carry out e.g. transactions such as payment.

It is also proposed that the multiplexer be constructed in the form of one single component with the reading unit. The cost of installation and a separate housing can be saved.

Alternatively, it is proposed that the multiplexer be constructed in the form of one single component with at least one of the control units. In this form of embodiment it may be possible that use can be made in the device of previously known reading units.

The proposal is made in an advantageous further development that the reading unit be constructed in the form of a writing/reading unit. In this form of embodiment, the possibility also exists for writing additional data on the card in addition to reading the data. Thus, for example, the pertinent data can be stored on the card in the event of establishing unauthorized use of the card in order to block further use of this card. These data can be made available by the computing unit, for example.

In a further embodiment of the present invention, the proposal is made that a communication link be capable of being established between the computing unit and a central control room. In this way, the card can be checked in terms of its validity prior to carrying out a payment transaction for example, whereby the data that are read are transmitted, via the computing unit, to a central control room that checks the validity of the means of payment. The result of such verification by the central control room is transmitted to the computing unit, which can then approve the means of payment for a payment transaction, for example. Alternatively, the corresponding data can be stored, via the reading unit, in the means of payment so that this reading unit is blocked for further use. The risk of misuse of a means of payment or unauthorized use of a card can be reduced.

It is also proposed that the device have an input unit. Thus user inputs, such as e.g. the selection of a type of transaction or the like, can be entered advantageously. The input unit can be linked to a control unit or it can even be constructed in the form of one single component with this control unit.

In a further embodiment, the proposal is made that the device have precisely one input opening. In this way, only one opening for the insertion and/or removal of the card can advantageously be provided through which all envisaged types of cards can be introduced. In addition, the risk of confusion during operation can be avoided since only one input opening is present for all types of cards.

A process for establishing a communication link to cards with different usage functions is also proposed via the invention, whereby a communication link to a card is established by means of a reading unit, which is suitable for the different card usage functions, the reading unit reads data from the card, the control unit that is suitable for communication with the card for the card usage function is determined on the basis of the data that have been read, and the communication link is established—via the reading unit—by means of a multiplexer between the control unit, which is suitable for communication with the card, and the card. User friendly operation of the device can be achieved. In addition, approval units for the reading units can be saved, whereby these approval units permit the input of a card into a suitable reading unit in the case of several reading units. For example, a determination which control unit is suitable can already be made by reading part of the data. However, it can also be provided that the data are transmitted to the multiplexer, which then determines the suitable control unit and establishes a communication link to said control unit. However, a third unit can also be provided that transmits a corresponding signal to the multiplexer after determining which control unit is suitable.

It is also proposed that, by means of the multiplexer, the reading unit communicate with a computing unit via one of at least two control units.

A direct link of the multiplexer to the computing unit can advantageously be dispensed with.

In addition, it is proposed that the data be transmitted to the computing unit. In this way, data can advantageously be made available that are required for obtaining authorization. The data can be transmitted, for further processing, to the control unit that is suitable for communication for the card usage function in question. The data can be stored in the computing unit and can also be used for verifying the authorization. Moreover, the data can be used for statistical purposes.

In an advantageous further development of the present invention, it is proposed that the control unit be activated via the computing unit, whereby this control unit is suitable for communication with the card for the usage function in question of the card. In this way, for example, the card usage function and the validity of the card can first be determined via the computing unit, whereby the control unit, which is suitable for communication, is activated as a function of the result. This way it is possible to obtain the authorization through a secure process.

It is also proposed that the reading unit establish a direct communication link to the control unit that is suitable for communication for the usage function of the card in question. Rapid data transfer with high security and increased reliability can be achieved.

In addition to this, the proposal is made that, by means of the multiplexer, one of the control units establish a communication link between the reading unit and the control unit that is suitable for communication for the usage function of the card in question. It can be achieved—particularly in the case where the multiplier is constructed in the form of one single component with the control unit—that any random control unit is linked directly to the reading unit for communication purposes even if the control unit, which is constructed in the form of one single component with the multiplexer, is not suitable for communication for the usage function of the card in question. This way a decrease in the number of modular units can be achieved.

It is also proposed that the activated control unit establish a direct communication link to the reading unit. It can be achieved that the control unit automatically forms a direct communication link to the reading unit regardless of the type of activation of the control unit.

As an alternative, it is proposed that, for communication purposes, the reading unit establish a communication link to the control unit that is suitable for the usage function of the card in question. Depending on the card that is introduced, the reading unit in this embodiment recognizes the usage function of the card and thus the competence of a particular control unit, which is then automatically activated. Activation can be provided, for example, only after the transmission of data to the computing unit. This way a simple process hierarchy can be achieved for carrying out the process.

In an advantageous further development of the present invention, it is proposed that authorizations that can be acquired with the card be issued to a communication unit. The communication unit can be formed, for example, by a key pad and a monitor as well as by a touch panel. As soon as a determination is made of the type of card that is present, the types of transaction, which are possible with this card, can be issued to the communication unit so that the selection possibilities can be made available to the user.

In addition, it is proposed that the process of obtaining authorization be carried out via the activated control unit in accordance with one of the possible authorizations that is selected by the user. The user can advantageously select the type of transaction that is most favorable for him. Depending on the type of transaction that is selected, bonuses and cash discounts, for example, can be provided this way during a payment transaction, whereby he [the user] enjoys these as a result of selecting a particular type of transaction. However, it can also be provided that the means of payment is used only as collateral, and the user is sent an invoice. User friendliness can be increased.

In addition, it is proposed that use be made of a magnetic card, a chip card, a cash card, a time card, an identification card, an EC card, or a credit card as the card. A plurality of different types of cards can thus be used without having to develop a multifunctional control unit. No risk of confusion exists in regard to the card being introduced into the wrong opening as is the case with an arrangement with several openings that are provided, in each case, for a different type of card. This is especially advantageous for vending machines, vending machines for tickets for travel purposes, or the like, in which payment can be made without cash.

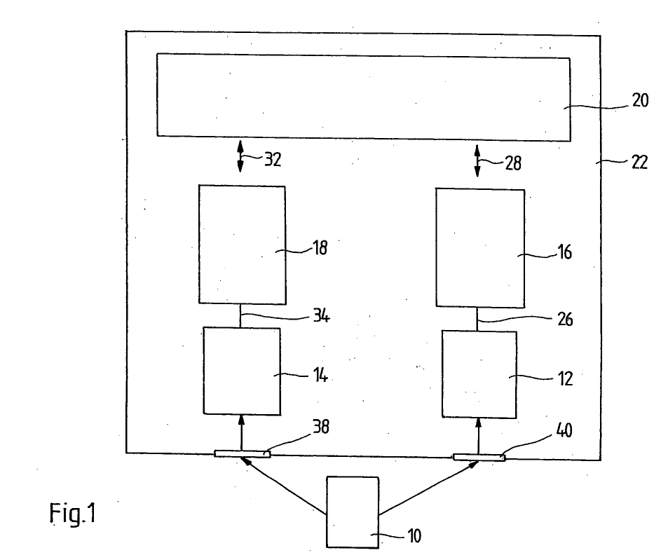

Additional advantages and features can be seen in the following description of examples of embodiments. Components that remain essentially the same are designated by the same reference numbers. In the case of identical features and functions, moreover, reference is made to the description of the example embodiment in FIG. 1. The drawings are merely schematic drawings, and serve only for elucidating the following examples of embodiments.

The drawings show.

FIG. 1 schematically shows the design of a device of the prior art with two separate input slots;

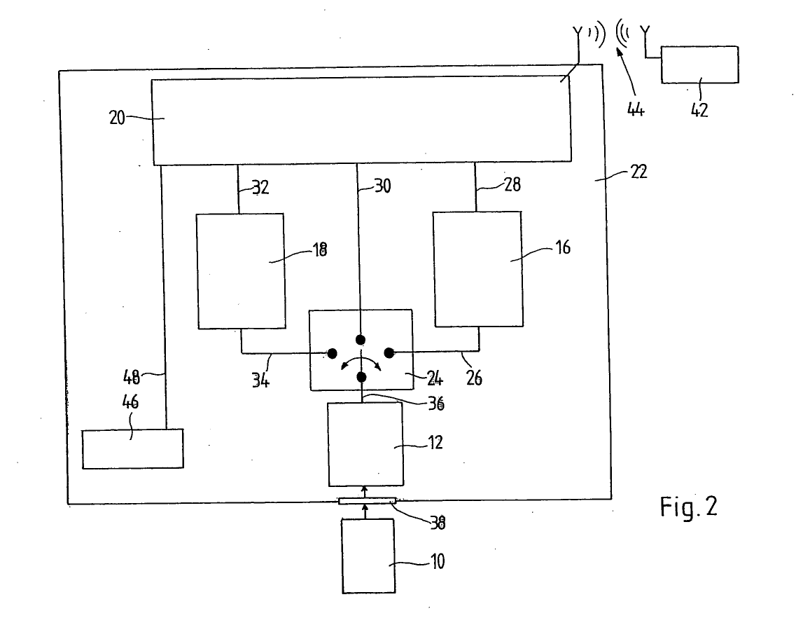

FIG. 2 shows a form of embodiment in accordance with the invention of a device with one input slot;

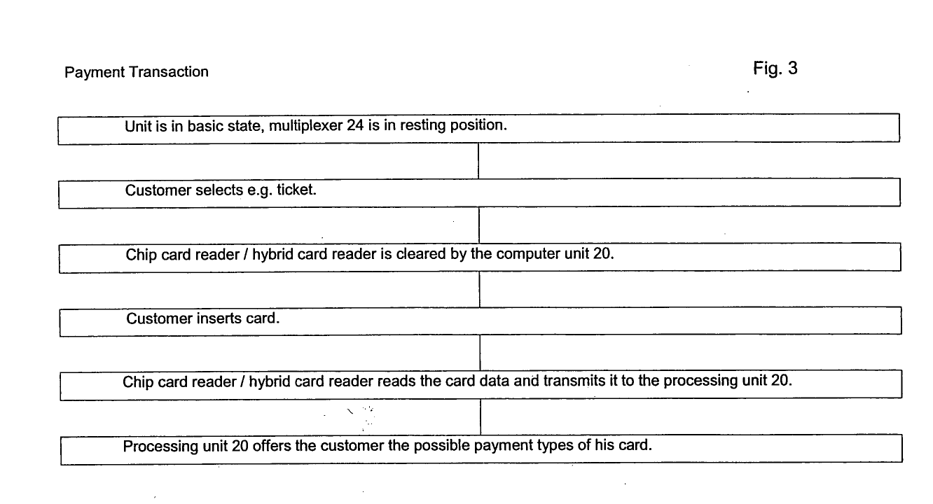

FIG. 3 shows a schematic flowchart in accordance with the invention for a payment transaction at a vending machine for tickets for travel purposes;

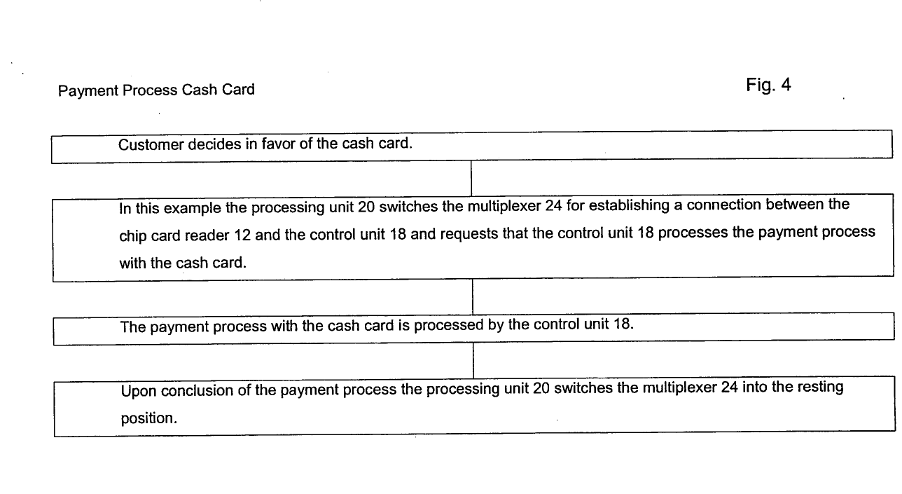

FIG. 4 shows a schematic flowchart in accordance with the invention for a payment transaction with a cash card;

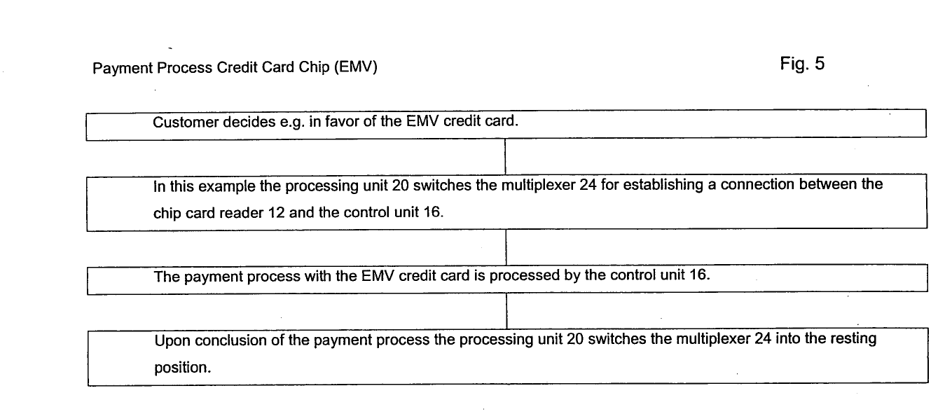

FIG. 5 shows a schematic flowchart in accordance with the invention for payment with a credit card.

FIG. 1 shows a device of the prior art for carrying out a non-cash payment transaction. The device comprises a housing 22 in which a computing unit 20 as well as two control units 16, 18 and two chip card readers 12, 14 are arranged. The chip card readers 12, 14 and the control units 16, 18 are each suitable for communication only for one specifically predefined card usage function. The control units 16, 18 are preferably standard control units that have already been approved for the envisaged card usage function. A means of payment, which is envisaged for one particular control unit, can be inserted, via input slots 38, 40, in the chip card reader 12, 14 that is linked to the associated control unit 16, 18. The chip card readers 12, 14 are linked, for communication purposes, to the associated control units 16, 18 via communication links 26, 34. The control units 16, 18, for their part, are linked, for communication purposes, to the computing unit 20 via communication links 28, 32. This represents a significant disadvantage of the prior artdue to the plurality of input slots 38, 40. The user has already decided, at the time of introducing his means of payment into one of the input slots, which of the control units will be activated. If the means of payment is erroneously introduced into the wrong input slot, then the control unit in question arranges for abortion of the payment transaction. The user now has to repeat all the actions that had previously been carried out in order, then, to carry out the payment transaction by introducing the means of payment into the correct input slot 38, 40. In addition, a chip card reader is required for each control unit.

In accordance with FIG. 2, this problem does not arise with the solution [to the aforementioned problem] according to the invention. The device in accordance with the invention also has a housing 22, in which a computing unit 20 and two control units 16, 18 are arranged that are each suitable for communication for a different usage function of the card 10. Here also, the control units 16, 18 are preferably standard control units with approval for a predefined card usage function. Contrary to the prior art, however, this device comprises only one chip card reader 12 that is linked to a multiplexer 24 via a communication link 36.

Accordingly, the housing 22 has only one input opening 38 via which a means of payment 10 can be fed to the chip card reader 12.

The multiplexer 24 is also linked, via the communication links 26, 30, 34, to the computing unit 20 and to the control units 16, 18. The control units 16, 18, for their part, are, in turn, linked directly to the computing unit 20 via the communication links 28, 32. The multiplexer 24 now makes available a change-over function with which the communication link 36 can optionally be linked to one of the communication links 26, 30, 34.

In the present embodiment, the multiplexer 24 in its idle position establishes a link between the communication link 30 and the communication link 36. Depending on the data from the means of payment 10 that are transmitted to the computing unit 20, the multiplexer 24 is then selected via the communication link 30 in such a way that the communication link 36 is linked to the corresponding associated communication link 26, 34 in order to link the chip card reader 12 to the control unit 16, 18 that is suitable for carrying out the payment transaction.

In addition, a touch panel 46 is arranged on the housing 22, whereby this touch panel is linked via a communication link 48 to the computing unit 20.

The sequence of events for a payment transaction can hereby be envisaged as follows (FIG. 3). At a Point-Of-Sale (POS), a user selects a product or service, which he would like to acquire, namely a ticket for public transportation in this case. The POS is linked to the computing unit 20 via a communication link that is not designated in more detail. This computing unit enables the chip reader 12. In order to carry out the payment transaction, the user now introduces his means of payment into the input slot 38. The means of payment 10 is forwarded from there to the chip card reader 12. This chip card reader reads the data from the means of payment 10, and transmits these data to the computing unit 20 via the communication links 30, 36. The computing unit 20 determines the type of the means of payment and sends a signal to the multiplexer 24 that establishes a corresponding communication link to the corresponding control unit 16, 18. The control unit 16, 18, for its part, transmits the possible payment transactions, which are permitted by the means of payment, to the computing unit via the communication links 28, 32. The computing unit 20 transmits the possible types of transactions to the touch panel 46 via the communication link 48. The user can now activate the desired type of transaction by means of finger pressure on the appropriate region of the touch panel. In the case of an EC card, for example, a chip for a cash card can be envisaged. A corresponding amount of money can either be debited from the chip of the cash card, or even credited by bank deposit via the EC system. The user selects the desired type of transaction. The type of transaction that is selected is again transmitted to the corresponding control unit 16, 18 via the computing unit 20. This control unit initiates the further course of events for the payment transaction.

FIG. 3 shows the corresponding sequence of events for the process in accordance with the invention for a vending machine for tickets for travel purposes. The starting position of the process is that the multiplexer 24 establishes a communication link between the computing unit 20 and the chip card reader 12. This position simultaneously constitutes the idle state of the multiplexer 24 that it automatically adopts after finishing or aborting a transaction. The customer selects the desired ticket for travel purposes. The amount of money that is due for this ticket is determined by the computing unit 20. The computing unit 20 then enables the reading unit 12 to receive a means of payment 10. The user now introduces his EC card with a cash card chip into the slot 38 from which it is forwarded to the reading unit 12 via a conveying system that is not designated in further detail. In the following step, the reading unit 12 reads the data from the means of payment 10 and transmits these data to the computing unit 20 via the multiplexer 24. The computing unit 20 transmits the possible types of transaction to the touch panel 46 that displays these possible types of transaction. The user can now activate a selection by touching the region [of the touch panel] that represents the type of payment transaction that is desired. This selection is transmitted to the computing unit 20, whereupon the corresponding control unit 16, 18 is activated in order to carry out the payment transaction in a known way.

FIG. 4 shows the sequence of events for the process in concrete terms, whereby the control unit 18 is provided for processing a cash card. In accordance with the sequence of events for the process that is illustrated in FIG. 4, the customer decides to make the payment by means of a cash card. The computing unit now arranges for the multiplexer 24 to establish a connection between the reading unit 12 and the control unit 18 in order that the payment can be processed by means of a cash card. After finishing the payment transaction, the computing unit 20 switches the multiplexer 24 to its idle position. In an alternative payment process, the user decides to make the payment by means of an EMV credit card. The user makes the corresponding selection by touching the appropriate region of the touch panel 46. The computing unit 20 arranges for the multiplexer 24 to establish a communication link between the reading unit 12 and the corresponding associated control unit 16 for payment by means of an EMV credit card. The payment transaction by means of an EMV credit card is processed by the control unit 16. After finishing the payment transaction, the computing unit 20 arranges for the multiplexer 24 to adopt its idle position once again (FIG. 5).

Thus it is possible by means of the invention that the user can carry out a payment transaction with any means of payment for which the device is provided. The nature of the means of payment is determined and, if required, the corresponding choice of types of payment transactions that are possible with this means of payment can be displayed. The user can select the desired type of payment transaction, and the transaction is carried out automatically in accordance with his request.

The examples of embodiments that are illustrated in the description and the associated figures serve merely to elucidate the invention and do not restrict said invention. In particular, the steps in the process can thus be modified or even combined in new ways, or additional functions can be provided in the device itself without departing from the scope of patent protection of this invention. The invention is, likewise, not limited to the implementation of payment transactions. It can also be used in the case of access systems or the like.

List of Reference Numbers

10 credit card
12 reading unit
14 reading unit
16 control unit
18 control unit
20 computing unit
22 housing
24 multiplexer
26 communication link
28 communication link
30 communication link
32 communication link
34 communication link
36 communication link
38 input slot
40 input slot
42 central control room
44 radio link
46 touch panel
48 communication link

1. Device for establishing a communication link to cards with different usage functions, comprising:
at least two control units that are each suitable for different card usage functions;
a reading unit, which is suitable for the different card usage functions; and
a multiplexer that is linked to the reading unit for communication purposes and by means of which the communication link can be established to one of the at least two control units that is suitable for the card usage function of a particular card.

2. Device in accordance with claim 1, further comprising a computing unit.

3. Device in accordance with claim 1, wherein the multiplexer is constructed as a single component with the reading unit.

4. Device in accordance with claim 1, wherein the multiplexer is constructed as a single component with at least one of the control units.

5. Device in accordance with claim 1, wherein the reading unit comprises a writing/reading unit.

6. Device in accordance with claim 1, wherein a second communication link can be established between the computing unit and a central control room.

7. Device in accordance with claim 1, further comprising an input unit.

8. Device in accordance with claim 1, further comprising precisely one input opening for the cards.

9. Method for establishing a communication link to cards that have different usage functions, comprising:
reading data from a card by means of reading unit which is suitable for the different card usage functions;
determining and activating one of a plurality of control units which is suitable for communication with the card for the particular card usage function on the basis of the data that have been read; and
establishing the communication link via the reading unit by means of a multiplexer between the activated control unit, which is suitable for said communication, and the card.

10. Method in accordance with claim 9, wherein the reading unit communicates via one of the plurality of control units with a computing unit by means of the multiplexer.

11. Method in accordance with claim 10, wherein the data are transmitted to the computing unit.

12. Method in accordance with claim 10, wherein the control unit which is suitable for communication with the card for the usage function of the card, is activated via the computing unit.

13. Method in accordance with claim 9, wherein the reading unit establishes a direct communication link with the control unit that is suitable for communication with the card for the particular usage function of the card.

14. Method in accordance with claim 9, wherein one of the control units establishes, by means of the multiplexer, a communication link between the reading unit and the control unit that is suitable for communication for the particular usage function of the card.

15. Method in accordance with claim 9, wherein the activated control unit establishes a direct communication link to the reading unit.

16. Method in accordance with claim 9, wherein the reading unit establishes a communication link for communication purposes to the control unit that is suitable for the particular usage function of the card.

17. Method in accordance with claim 9, wherein a process of obtaining authorization is carried out via the activated control unit in accordance with one of possible authorizations that are selected by a user.

18. Method in accordance with claim 9, wherein the card comprises a magnetic card, a chip card, a cash card, a time card, an identification card, an EC card, or a credit card.
